(19) United States
(12) Patent Application Publication
(10) Pub. No.: US 2017/0154240 A1
(43) Pub. Date: Jun. 1, 2017

(54) METHODS AND SYSTEMS FOR IDENTIFYING AN OBJECT IN A VIDEO IMAGE

(71) Applicant: Vloggsta Inc., Plano, TX (US)

(72) Inventors: George Vogiatzis, London (GB); Noa Garcia, Birmingham (GB); Marco Fiocco, Essex (GB); Alexander G. Ross, London (GB)

(73) Assignee: Vloggsta Inc., Plano, TX (US)

(21) Appl. No.: 15/365,303

(22) Filed: Nov. 30, 2016

(30) Foreign Application Priority Data
Dec. 1, 2015 (GB) 1521218.6

(51) Int. Cl. G06K 9/62; H04N 5/232; H04N 7/18; G06T 7/00; G06K 9/46

(52) U.S. Cl. CPC G06K 9/6202; G06T 7/004; G06K 9/4604; H04N 7/185; H04N 5/23293; G06T 2207/10016; H04M 2250/52

(57) ABSTRACT

A smart phone (101) captures an image (113) of a video frame of a movie and sends it to a server (107) for comparison with data stored in a database (112) for determining the title of the movie and identifying the particular video frame in the movie. Another database (110) is interrogated whereby items of merchandise contained in the image of the identified video frame are extracted and displayed on the smartphone along with brand names and a retailer's details. To reduce processing time and the amount of data stored, data relating to only a subset of the total video frames comprising a movie are stored in the database (112). The user may also request to have displayed on the smartphone's screen (102), one of several frames preceding or following the captured frame and request information on items of merchandise displayed in such frames.

### CROSS-REFERENCE TO RELATED APPLICATION

This Patent Application claims priority to United Kingdom Patent Application Serial Number 1521218.6 titled METHODS AND SYSTEMS FOR IDENTIFYING AN OBJECT IN A VIDEO IMAGE and filed Dec. 1, 2015, the entire contents of which is herein incorporated by reference in its entirety.

### BACKGROUND OF THE INVENTION

1. Field of the invention

The field of this invention relates to video fingerprinting and particularly to methods and systems for the identification of an object in a video image.

2. Description of the Related Art

Video fingerprinting methods extract several unique features of a digital video image that can be stored as ‘fingerprint’ of the video content. Identification of the video content can be performed by comparing the extracted video fingerprint with a reference fingerprint which has been previously created from a copy of the video. In the related fields of computer vision and image processing, a feature may be a specific structure in an image such as a point, edge or object. A representation of a specific image feature is known as a feature descriptor.

### SUMMARY OF THE INVENTION

Aspects of the invention provide systems and methods for identifying an object in a video frame as described in the appended claims.

According to a first aspect of invention there is provided a method for identifying an object in a video frame in a sequence of video frames, the method comprising: in a user device, capturing an image of a video frame of the sequence of video frames containing the object to be identified, generating feature descriptors representing the captured image, sending the generated feature descriptors to a server; in the server, determining and storing feature descriptors for a plurality of video frames in a copy of the sequence of video frames, storing in an inventory, identifiers of objects contained in at least one video frame in the copy of the sequence of video frames, receiving the generated feature descriptors representing the captured image, comparing the generated feature descriptors representing the captured image with the stored feature descriptors to find a matching video frame, extracting from the inventory, identifiers of objects contained the matching video frame, sending the identifiers of the objects contained in the matching video frame to the user device for display to a user of the user device.

According to a second aspect of the invention, there is provided a system for identifying an object in a video frame in a sequence of video frames, the system comprising: a user device including; a visual display, an image capture apparatus for capturing an image of a video frame of the sequence of video frames containing the object to be identified, and a processing circuit for generating feature descriptors representing the captured image; and a server comprising signal processing circuitry and an inventory for storing identifiers of objects contained in at least one video frame in a copy of the sequence of video frames, wherein the user device is arranged to send the generated feature descriptors to the server and wherein the signal processing circuitry is arranged to determine and store feature descriptors for a plurality of video frames in the copy of the sequence of video frames, and to receive, from the user device, the generated feature descriptors representing the captured image, compare the generated feature descriptors representing the captured image with the stored feature descriptors to find a matching video frame, extract from the inventory, identifiers of objects contained the matching video frame, and send the identifiers of the objects contained in the matching video frame to the user device for display on the visual display.

In one example, the sequence of video frames is a movie and an object contained in a captured video frame may be an item of merchandise such as an automobile or an item of clothing such as a jacket, dress or shoe, for example, worn by an actor in the movie. The user of the user device may be especially interested in the object and may desire to know, for example, its brand name and where a similar item could be purchased.

An identifier of an object may comprise a visual representation of the object for display to a user on a display screen of the user device. Identifiers of objects contained in all video frames in the copy of the sequence of video frames may be stored. In one example, the user of the user device selects the object displayed on the screen, for example by touching a soft key or the representation of the object, if the screen is a touchscreen. In response, the user device sends a request to the signal processing circuitry for more information about the selected object. The signal processing circuitry may then interrogate the inventory and extract details of, for a web address) of a retailer who can supply the object and send the details to the user device for display to the user.

Generating feature descriptors from the captured image and determining feature descriptors of frames in a copy of the sequence of video frames may be based on one of several known techniques or algorithms such a SIFT (Scale Invariant Feature Transform).

Finding a matching video frame may make use of known database searching techniques, the so-called content-based image retrieval process (sometimes referred to as “query by image content”) and other algorithms evolved from pattern recognition and computer vision techniques, for example. In some embodiments, a captured frame is compared with a reference frame using an image distance measure. An image distance measure typically compares the similarity of two images in various dimensions such as color or shape. A distance of zero signifies an exact match with the query with respect to the dimensions that were considered.

A typical movie lasting at least one hour will contain a large number of video frames (a frame rate of 24 frames per second is typical). Data on a plurality of movies may be stored at the server. In order to reduce the amount of data required to be stored and also to reduce the searching time for a match, in one embodiment, feature descriptors are determined for one in every N frames of the sequence of frames rather than all N frames of the movie. N is an integer, typically equal to eight. In general, little information will be lost as typically there are very small changes and sometimes none at all from one (of most) video frames to the next.

In one embodiment, the signal processing circuitry is arranged to extract from a store one or more video frames preceding or following a captured video frame in response to a request from the user device and to send the extracted video frame to the user device for display to the user.

The user device may be a mobile phone or ‘smartphone’ or tablet or similar handheld computing device which includes a camera and the processing circuit for generating the feature descriptors.

The functionality for generating the feature descriptors may be pre-provisioned into the processing circuit or may be downloaded into the processing circuit as an application or “app.”

In one embodiment, the user device also has a GPS (Global Positioning System) capability and the processing circuit is arranged to send the user's location to the server. This information may be used by the signal processing circuitry in the server for marketing purposes as described below.

In some embodiments, the processing circuit in the user device may be arranged to send the title of the movie from which the video frame has been captured. This can be done by voice input and text message, for example. Knowing the title of the movie can reduce the search time and improve the accuracy of finding a matching video frame at the server.

The signal processing circuitry may be incorporated in an integrated circuit. The components of the server may be co-located or the server may comprise a distributed system.

According to a third aspect of the invention, there is provided a tangible computer program product having executable program code stored thereon for executing a process to perform a method in accordance with the first aspect.

The tangible computer program product may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

These and other aspects, features and advantages of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

Like reference numerals have been included in the respective drawings to ease understanding.

FIG. 1 is a simplified schematic block diagram of a system for identifying an object in a video frame in accordance with an example embodiment; and

FIG. 2 is a simplified flowchart illustrating a method for identifying an object in a video frame in accordance with an example embodiment; and FIG. 3 shows a touchscreen display displaying identified objects.

### DETAILED DESCRIPTION OF THE PREFERRED EMBODIMENTS

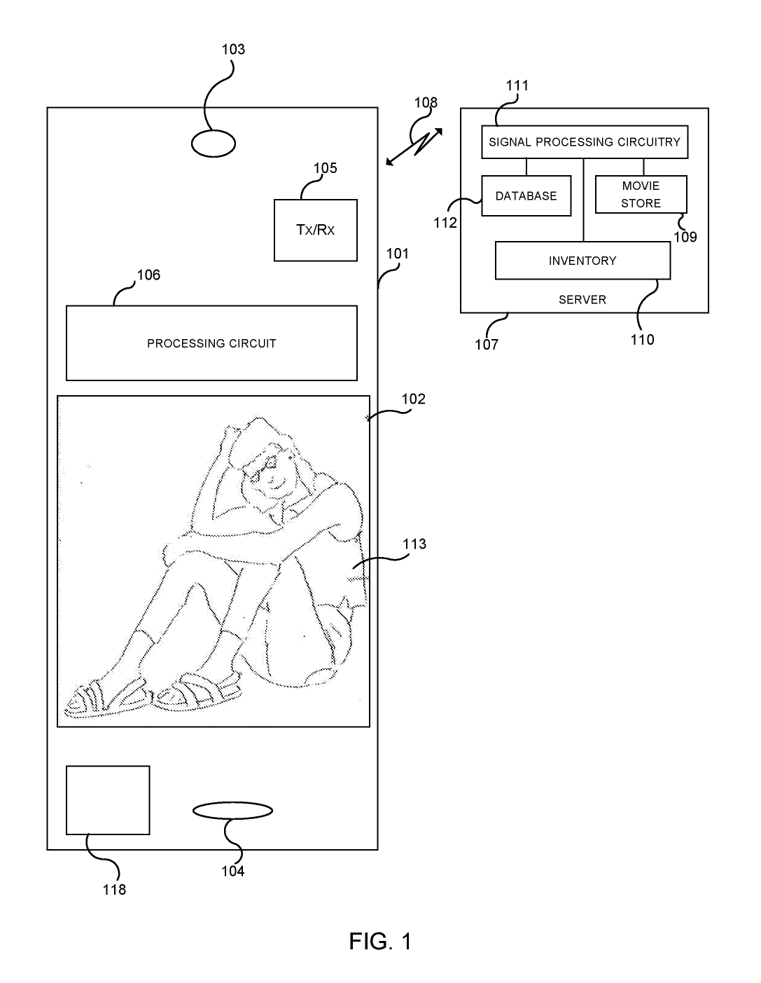

Referring to FIG. 1, a user device such as a smartphone 101 is provided with a touchscreen 102, a camera 103, a microphone 104, transmitting and receiving circuitry, (Tx/Rx) 105 and a processing circuit 106. The smartphone may be provided with other conventional features and functionality (not shown) to enable it to operate as a personal communications device. The processing circuit 106 is configured to generate feature descriptors representing an image captured by the camera 103. The image captured by the camera is displayed on the touchscreen 102 to the user. The smartphone 101 may communicate using the transmitting and receiving circuitry 105 with a remote server 107 over a wireless link 108. Alternatively, a user device may communicate with the remote server via a direct link.

The server 107 includes a movie store 109 and an inventory 110. The movie store 109 holds copies of one or more movies comprising a sequence of video frames. The inventory 110 holds identifiers of objects, that is, items of merchandise, which are shown in the movies held in the movie store 109. Coupled to the movie store 109 and to the inventory 110 is signal processing circuitry 111, also located in the server.

The signal processing circuitry 111 is configured to determine feature descriptors of video frames of the movies stored in the movie store 109 and to store the determined feature descriptors in a database 112 also located in the server 107. The signal processing circuitry 111 is also configured to compare feature descriptors received over the wireless link 108 from the smartphone 101 with feature descriptors stored in the database 112, identify a matching video frame, interrogate the inventory 110 to extract identifiers of items shown in the identified frame and send information relating to the items to the smartphone 101 for display to the user on the touchscreen 102.

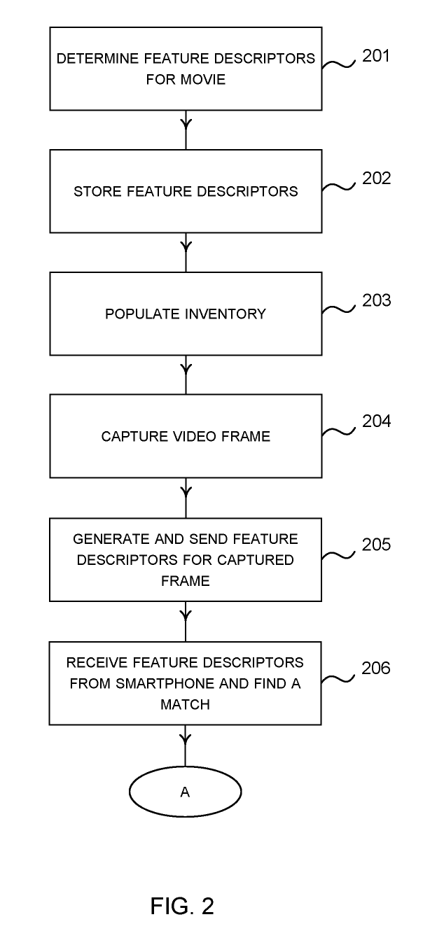

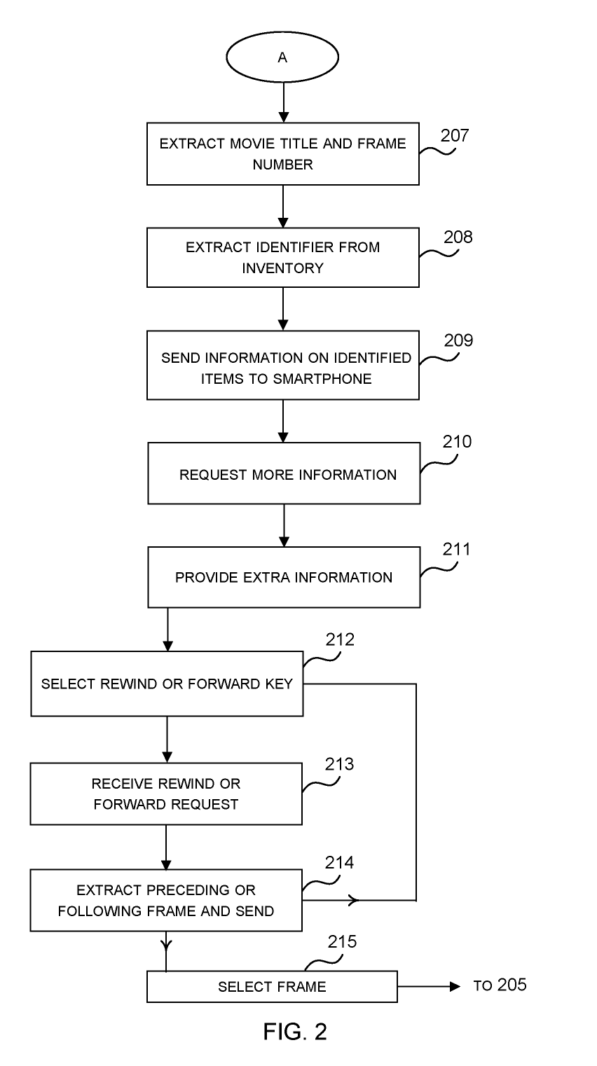

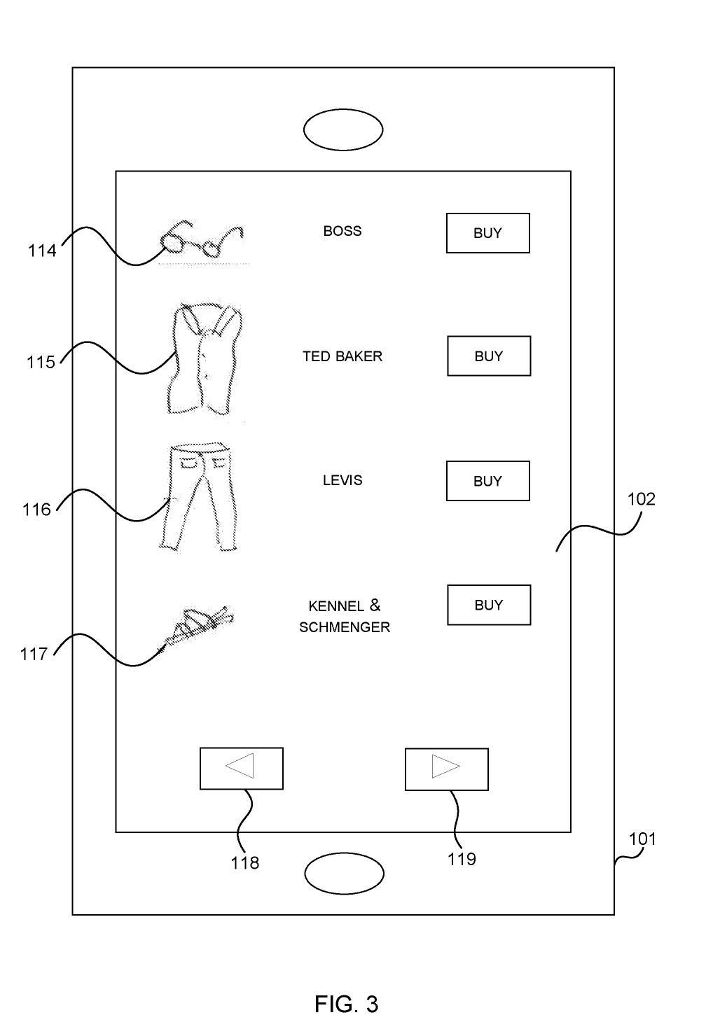

Some examples of the operation of the system of FIG. 1 will now be described with reference to the flowchart FIG. 2 and to FIGS. 1 and 3.

At 201, feature descriptors are determined by the signal processing circuitry 111. Say for example that a first movie entitled “The Journey” stored in the movie store 109 comprises a total number of “M” video frames. In this example, the signal processing circuitry 111 samples every eighth video frame of the M total video frames so that M/8, say “m” video frames are actually sampled. For each of the sampled ‘m’ video frames, the signal processing circuitry 111 determines feature descriptors in accordance with a conventional technique.

At 202, the determined feature descriptors are stored in the database 112. The database 112 is arranged so that each consecutive sampled video frame has a set of determined feature descriptors associated therewith and also, has a frame number assigned to it and has the movie title associated with it.

Typically, a list of items of merchandise, such as clothing and “props” such as furniture, automobiles for example, which are used when producing a movie, is prepared by the producers of the movie. This list is used to populate the inventory 110. By comparison of the list of items of merchandise with the ‘m’ video frames, the contents of the inventory can be prepared, at 203, whereby each of the m frames identified by movie title and its frame number has one or more items associated with it, the items being those shown in that particular video frame. In one example, the inventory can hold information relating to a visual representation of such items. In other examples, an identifier of an item may be a descriptive term such as “shirt” or “car.” Further information on items such as brand name and details of a retailer from which the item can be purchased is also stored in the inventory 110.

In a first example, the user of the smartphone 101 is watching a movie, perhaps at the cinema or at home, and is interested to know where he/she might purchase items of clothing similar to those worn by an actor in the movie. At 204, the camera 103 in the smartphone 101 captures an image of a currently displayed video frame containing the items of interest to the user. Referring briefly to FIG. 1, the captured image 113 is displayed to the user on the touchscreen 102. The image 113 reveals a pair of sandals. The user wishes to know the brand names of these items and where there might be purchased.

At 205 the processing circuit 106 in the smartphone 101 generates feature descriptors representing the captured image 113 and sends them to the server 107.

At 206, the signal processing circuitry 111 in the server 107 receives the generated feature descriptors from the smartphone 101 and looks for a match by comparing them with feature descriptors stored in the database 112. The comparison process may be performed using conventional techniques. The process may not necessarily look for an exact match but may look for a best match with regard to some predetermined criterion.

When a match has been found, the signal processing circuitry 111 can extract, at 207, from the database the title of the movie in question and the frame number of the frame which is a best match to the data provided by the smartphone 101.

Now that the signal processing circuitry 111 knows the identity of the movie and a frame number, at 208 it interrogates the inventory 110 and extracts the identifiers of items associated with the identified movie and frame. In this example, the identifiers are visual representations of the items of clothing shown in the captured image 113.

At 201, the signal processing circuitry 111 sends information relating to the items of clothing to the smartphone 101 and at 210, the smartphone displays visual representations of the relevant items. FIG. 3 illustrates the display screen 102 showing the items 114-117 and their brand name with a soft key alongside each Item labeled ‘BUY’ which the user can touch if he/she wishes to buy the product.

At 209, the user can request more information by touching the ‘BUY’ soft key which in turn, sends the request to the server 107.

At 211 the signal processing circuitry 111 responds to the request by extracting from the inventory 110 information concerning an appropriate retailer (and purchase prices if available) and sends this information back to the smartphone 101.

In another embodiment, the smartphone 101 is provided with a GPS system 118 (see FIG. 1) and the processing circuit 106 is configured to send the location of the smartphone to the server 107. With reference to FIG. 2, this may be done at step 205 (in addition to sending the generated feature descriptors). The signal processing circuitry 111 may use this location information to obtain a name and address of a retailer in close proximity to the user. Such information may be pre-provisioned in the inventory at step 203, for example, or the signal processing circuitry 111 may interrogate some remote database to find the information. The signal processing circuitry 111 may also use this location information to send to the user advertising or marketing material.

In a further embodiment the processing circuit 106 and the signal processing circuitry 111 are configured to supplement the feature descriptor and matching processes at steps 201, 202, 205 and 206 with either a watermark audio process or an audio fingerprinting process or both. Audio watermarking and audio fingerprinting are known techniques. Either or both techniques may be used to assist the frame matching process (steps 206 and 207), provided of course that the database 112 has been pre-provisioned with soundtracks of the relevant movies. In such embodiments, the microphone 104 of the smartphone 101 is utilized to capture a section of the relevant soundtrack from the movie being watched.

In another embodiment, the title of the movie being watched by the user is sent from the smartphone 101 to the signal processing circuitry 111 in the server 107. Utilizing the microphone 104 on the smartphone 101 the user utters the title of the movie ‘The Journey’ for example. The utterance is captured in the smartphone 101 and converted by a voice-to-text engine in the processing circuit 106 into text. The processing circuit 106 is also provisioned with a store of movie titles which it interrogates to find a match with the converted text. Once the movie in question has been identified, information relating to the title of the movie is sent to the signal processing circuitry 111 in the server 107. Knowledge of the movie title by the signal processing circuitry 111 advantageously reduces the time taken to find a matching video frame in the database 112.

A further embodiment will now be described. With reference to FIG. 3, the touch screen 102 displays a rewind soft key 118 and a forward soft key 119. These keys may be used when the user of the smartphone wishes to see one or more of a number of video frames (typically 10) which either precede or follow the captured video frame displayed in the captured image 113.

Referring again to FIG. 2, at 212, the user may select either the rewind or the forward key. Say for example that the captured video frame was not actually the one that the user intended to capture but that the frame of interest either preceded (or followed) the captured one, perhaps by two or three frames but the user is not quite sure. In this case, the user taps the rewind (or forward) key 118 once whereupon a request is sent from the smartphone 101 and received at 213 by the signal processing circuitry 111 in the server 107.

In response, at 214, the signal processing circuitry 111 extracts the preceding (or following) video frame from the movie store 109 and sends it to the smartphone 101 for display on the touchscreen 102.

If the user wishes to see the next preceding (or following) frame; that is, two frames back (or forward) from the captured frame, he can tap the rewind (or forward) key once more, so the process from 212 onwards may repeat until the video frame that the user is interested in is displayed on the touch screen 102. At this point, at 215 the user can select the displayed frame by tapping the image on the touch screen 102, for example, whereupon the process can revert to step 205. In this way, the user may be presented with information concerning objects (that is; items of merchandise listed in the inventory 110) associated with a multiplicity of video frames, both following and preceding the frame that was initially captured.

The signal processing functionality of the embodiments of the invention, particularly the processing circuit of the user device and the signal processing circuitry in the server, may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface , such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms “computer program product”, “computer-readable medium” and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as “computer program code” (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order.

Rather, the steps may be performed in any suitable order. In addition, singular references do not exclude a plurality. Thus, references to “a”, “an”, “first”, “second”, etc. do not preclude a plurality.

1. A method for identifying an object in a video frame in a sequence of video frames, the method comprising:
in a user device, capturing an image of a video frame of the sequence of video frames containing the object to be identified, generating feature descriptors representing the captured image, and sending the generated feature descriptors to a server; and
in the server, determining and storing feature descriptors for a plurality of video frames in a copy of the sequence of video frames, storing in an inventory, identifiers of objects contained in at least one video frame in the copy of the sequence of video frames, receiving the generated feature descriptors representing the captured image, comparing the generated feature descriptors representing the captured image with the stored feature descriptors to find a matching video frame, extracting from the inventory, identifiers of objects contained in the matching video frame, and sending the identifiers of the objects contained in the matching video frame to the user device for display to a user of the user device.

2. The method of claim 1 wherein an identifier of an object comprises a visual representation of the object and wherein the method comprises displaying said visual representation on a display screen of the user device.

3. The method of claim 2 comprising sending information relating to an identified object in response to a request from the user device.

4. The method of claim 3 comprising generating and determining feature descriptors.

5. The method of claim 4 comprising finding a matching video frame using a content-based image retrieval process.

6. The method of claim 5 comprising generating and determining feature descriptors are determined for one in every N frames of the sequence of frames, where N is an integer.

7. The method of claim 1 comprising extracting from a store a video frame preceding or following a captured video frame in response to a request from the user device and sending the extracted video frame to the user device for display to the user.

8. The method of claim 7 comprising sending identifiers of objects contained in the extracted video frame to the user device for display to the user in response to a request from the user.

9. A system for identifying an object in a video frame in a sequence of video frames, the system comprising:
a user device including a visual display, an image capture apparatus for capturing an image of a video frame of the sequence of video frames containing the object to be identified, and a processing circuit for generating feature descriptors representing the captured image; and
a server comprising signal processing circuitry and an inventory for storing identifiers of objects contained in at least one video frame in a copy of the sequence of video frames,
wherein,
the user device is arranged to send the generated feature descriptors to the server, and
the signal processing circuitry is arranged to determine and store feature descriptors for a plurality of video frames in a copy of the sequence of video frames, and to receive, from the user device, the generated feature descriptors representing the captured image, compare the generated feature descriptors representing the captured image with the stored feature descriptors to find a matching video frame, extract from the inventory, identifiers of objects contained in the matching video frame, and send the identifiers of the objects contained in the matching video frame to the user device for display on the visual display.

10. The system of claim 9 wherein the signal processing circuitry is arranged to extract from a store a video frame preceding or following a captured video frame in response to a request from the user device and to send the extracted video frame to the user device for display to the user.

11. The system of claim 10 wherein the user device is a mobile phone or “smartphone” or tablet or hand-held computing device which includes a camera and the processing circuit for generating the feature descriptors.

12. The system of claim 9 wherein the sequence of video frames is a movie and an object contained in a captured video frame is an item of merchandise.

13. The system of claim 9 wherein the signal processing circuitry is incorporated in an integrated circuit.

14. The system of claim 9 wherein the user device includes a GPS (Global Positioning System) capability and the processing circuit is arranged to send the user's location to the server.

15. The system of claim 9 wherein the sequence of video frames is a movie and the processing circuit is arranged to send information relating to the title of the movie to the server.

16. The system of claim 15 wherein the title of the movie is recorded in the user device by voice input.

17. The system of claim 15 wherein the voice input is converted to text and the information is sent to the server by text messaging.

18. A tangible computer program product having executable program code stored thereon for executing a process to perform a method according to claim 1.

19. The tangible computer program product of claim 18 wherein the tangible computer program product comprises at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

20. (canceled)

21. (canceled)
